(19) United States
(12) Patent Application Publication
(10) Pub. No.: US 2026/0332524 A1
(43) Pub. Date: Oct. 22, 2026

(54) NETWORK DEVICE AND NETWORK CONTROL METHOD

(71) Applicant: ASUSTEK COMPUTER INC., TAIPEI (TW)

(72) Inventors: Tsung-Jen HUANG, TAIPEI (TW); Meng-Chieh HUANG, TAIPEI (TW); Chang-Yi SHEN, TAIPEI (TW)

(21) Appl. No.: 19/238,941

(22) Filed: Jun. 16, 2025

(30) Foreign Application Priority Data
Apr. 17, 2025 (TW) 114114562

(51) Int. Cl. H04L 45/74; H04L 9/40; H04L 61/2514

(52) U.S. Cl. CPC H04L 45/74; H04L 61/2514; H04L 63/0236

(57) ABSTRACT

The network device provided is adapted to connect to a local area network (LAN) and a wide area network (WAN) to receive a network packet, and has a forward chain. The forward chain is adapted to perform content inspection on the network packet before transmitting the network packet to the WAN. The network device includes a network packet determination unit and a network address translation (NAT) unit. The network packet determination unit is adapted to determine whether a destination address of the network packet is a LAN address. The NAT unit is electrically coupled to the network packet determination unit, and is adapted to perform address translation on the destination address. When the destination address is the LAN address, the NAT unit translates the destination address into a WAN address, and sends the network packet to the forward chain for content inspection. The disclosure also provides a network control method.

### CROSS-REFERENCE TO RELATED APPLICATION

This application claims the priority benefit of Taiwan Application Serial No. 114114562, filed on Apr. 17, 2025. The entirety of the above-mentioned patent application is hereby incorporated by reference herein and made a part of specification.

### BACKGROUND OF THE INVENTION

### Field of the Invention

The disclosure relates to a network device and a network control method thereof, and in particular, to a network device located at a connection point between a local area network (LAN) and a wide area network (WAN) and a network control method thereof.

### Description of the Related Art

The current deep packet inspection (DPI) is to intercept and inspect a packet in the middle when a router is forwarding a network packet. The forwarding of the router mainly occurs in a situation where a network packet is transmitted from a wide area network (WAN) device to a local area network (LAN) device or from the LAN device to the WAN device, which involves operation of a network layer.

However, in the current architecture of the router, a packet in a LAN is directly transmitted from the LAN device a source to the LAN device as a destination on a data link layer (that is, a media access control (MAC) layer). The packet does not pass through a checkpoint in the network for DPI, and therefore does not effectively protect the LAN.

### BRIEF SUMMARY OF THE INVENTION

The disclosure provides a network device. The network device is adapted to connect to a local area network (LAN) and a wide area network (WAN) to receive a network packet, and has a forward chain. The forward chain is adapted to perform content inspection on the network packet before transmitting the network packet to the WAN. The network device includes a LAN port, a WAN port, a network packet determination unit, and a network address translation (NAT) unit. The LAN port is adapted to be electrically coupled to the LAN. The WAN port is adapted to be electrically coupled to the WAN. The network packet determination unit is electrically coupled to the LAN port, and is adapted to determine whether a destination address of the network packet is a LAN address. The NAT unit is electrically coupled to the network packet determination unit, and is adapted to perform address translation on the destination address. When the destination address is the LAN address, the NAT unit translates the destination address into a WAN address, and sends the network packet to the forward chain for content inspection.

The disclosure also provides a network control method, applicable to a network device. The network device is connected to a LAN and a WAN to receive a network packet, and has a forward chain. The forward chain is adapted to perform content inspection on the network packet before transmitting the network packet to the WAN. The network control method includes the following steps. First, it is determined whether a destination address of the network packet is a LAN address. When the destination address is the LAN address, the destination address is translated into a WAN address, and the network packet is sent to the forward chain for content inspection.

The current deep packet inspection (DPI) is to intercept and inspect a packet in the middle when a router is forwarding a network packet. However, in the current architecture of the router, a packet in the LAN is transmitted on a data link layer (that is, a media access control (MAC) layer). The packet does not pass through a checkpoint in the network for DPI, and therefore does not effectively protect the LAN. Through the network device and the network control method provided in the disclosure, the destination address of the packet of the LAN is translated into a WAN address, so that the packet is forwarded from the LAN to the WAN for content inspection, and then the packet is forwarded from the WAN back to the LAN through a communication port forwarding mechanism. In this way, DPI is performed on the packet to perform further network security protection.

### BRIEF DESCRIPTION OF THE DRAWINGS

FIG. 1 shows a network architecture applicable to a network device in the disclosure;

FIG. 2 is a schematic block diagram of a network device according to an embodiment of the disclosure; and

FIG. 3 is a flowchart of a network control method according to an embodiment of the disclosure.

### DETAILED DESCRIPTION OF THE EMBODIMENTS

Specific embodiments of the disclosure are described in more details below with reference to the schematic diagrams. Advantages and features of the disclosure are to be clearer based on the following descriptions and claims. It is to be noted that all figures are in a very simple form and in an inaccurate proportion, and are merely intended to assist in convenient and clear description of the embodiments of the disclosure.

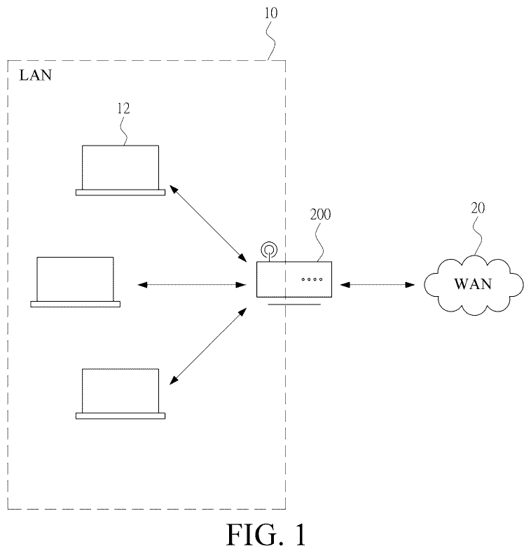

FIG. 1 shows a network architecture applicable to a network device 200 in the disclosure.

The disclosure provides a network device 200. The network device 200 is adapted to connect to a local area network (LAN) 10 and a wide area network (WAN) 20. At least one terminal device 12 is arranged in the LAN 10.

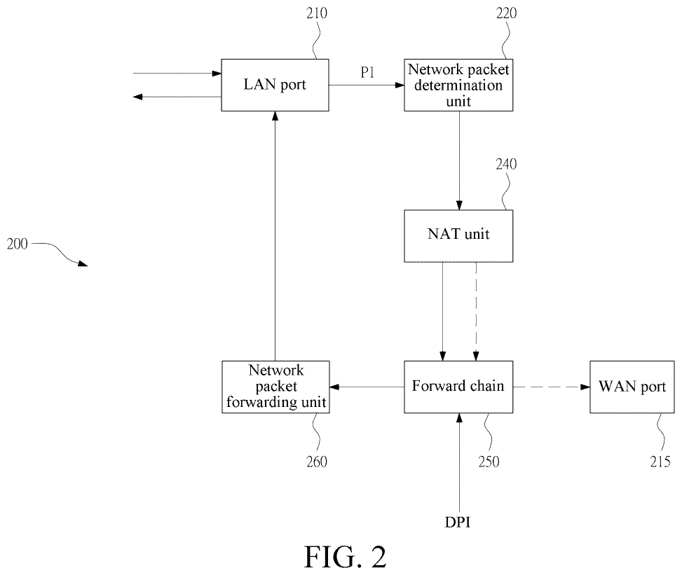

Refer to FIG. 2 additionally. FIG. 2 is a schematic block diagram of a network device 200 according to an embodiment of the disclosure.

As shown in the figure, the network device 200 is adapted to receive a network packet P1, and has a forward chain 250. The forward chain 250 is adapted to perform content inspection on the network packet P1 before transmitting the network packet P1 to the WAN 20. Specifically, the forward chain 250 is adapted to perform deep packet inspection (DPI) on network packet P1, and inspection content thereof includes content of the network packet P1. The forward chain 250 and the DPI are software frameworks in the current LINUX core, which are not the focus of the disclosure and are known in this technical field. Details are not described herein.

The network device 200 includes a LAN port 210, a WAN port 215, a network packet determination unit 220, a network address translation (NAT) unit 240, and a network packet forwarding unit 260.

The LAN port 210 is adapted to be electrically coupled to the LAN 10 to receive a network packet from the LAN 10 or send the network packet to the LAN 10. The WAN port 215 is adapted to be electrically coupled to the WAN 20 to receive a network packet from the WAN 20 or send the network packet to the WAN 20.

The network packet determination unit 220 is electrically coupled to the LAN port, and is adapted to determine whether a destination address of the network packet P1 is a LAN address. A solid arrow in the figure represents a transmission path of the network packet P1 when the destination address is the LAN address. A dashed arrow represents a transmission path of the network packet P1 after the determination by the network packet determination unit 220 when the destination address is not the LAN address.

The NAT unit 240 is electrically coupled to the network packet determination unit 220, and is adapted to perform address translation on the destination address. When the destination address of the network packet P1 is the LAN address, the NAT unit 240 translates the destination address into a WAN address and sends the network packet P1 to the forward chain 250 for content inspection.

The network packet forwarding unit 260 is electrically connected to the NAT unit 240, and is adapted to forward, from the WAN address back to the LAN address (that is, the original destination address of the network packet P1) through a communication port forwarding mechanism, the destination address of the network packet P1 that is determined to be non-malicious after inspection. Specifically, the network packet P1 is transmitted to a specific terminal device 12 of the LAN 10 through the LAN port 210.

Communication port forwarding is an application of NAT, which is mainly to forward a connection request with an address and a communication port (as for the disclosure, that is, the WAN address and a communication port thereof) to a specified address and communication port (as for the disclosure, that is, the original destination address and a communication port thereof) when the network packet P1 passes through a gateway (such as a router or a firewall).

On the contrary, when the destination address of the network packet P1 is the WAN address, the network packet P1 is transmitted to the forward chain 250, and after it is determined that the network packet P1 is not harmful, the network packet is then transmitted to the WAN 20 through the WAN port 215.

In an embodiment, the network device 200 is a router, a switch, or a gateway.

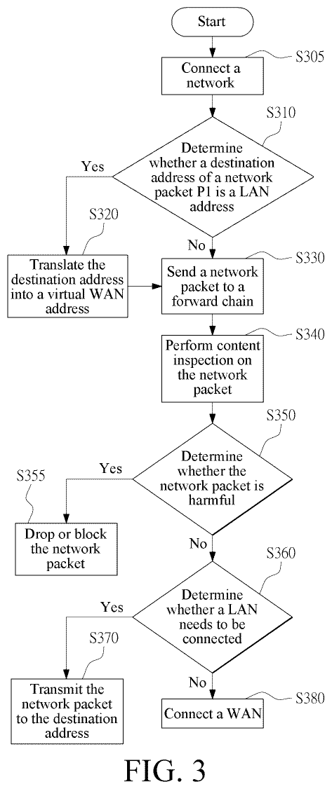

FIG. 3 is a flowchart of a network control method according to an embodiment of the disclosure.

The disclosure also provides a network control method, applicable to a network device 200. The network device 200 is connected to a LAN 10 and a WAN 20 to receive a network packet P1, and has a forward chain 250. The forward chain 250 is adapted to perform content inspection on the network packet P1 before transmitting the network packet P1 to the WAN 20.

The network control method includes the following steps.

First, as described in step S305, a network is connected.

Then, as described in a determination step S310, it is determined whether a destination address of the network packet P1 is a LAN address. The step is performed by the network packet determination unit 220 in FIG. 2.

When the destination address is the LAN address, this process proceeds to step S320 of translating the destination address into a WAN address. Then, as described in step S330, the network packet P1 is sent to the forward chain 250. The foregoing step is performed by the NAT unit 240 in FIG. 2.

On the other hand, when the destination address is the WAN address, this process directly proceeds to step S330 of sending the network packet P1 to the forward chain 250.

Carrying on with step S330, as described in step S340, after the network packet P1 is sent to the forward chain 250, the DPI function is then triggered to perform content inspection on the network packet P1.

Next, as described in a determination step S350, it is determined whether the network packet P1 is harmful. This step is to determine, through the DPI function, whether the network packet P1 involves a malicious behavior.

When it is determined that the network packet P1 is harmful, this process proceeds to step S355 of dropping or blocking the network packet P1.

On the other hand, when it is determined that the network packet P1 is not harmful, this process proceeds to a determination step S360 of determining whether the LAN 10 needs to be connected to transmit the network packet P1.

When a determination result of the determination step S360 is yes, this process proceeds to step S370 of forwarding the network packet P1 from the WAN address to the original destination address through a communication port forwarding mechanism. The step is performed by the network packet forwarding unit 260 in FIG. 2.

When the determination result of determination step S360 is no, it indicates that a destination of the network packet P1 is the WAN 20. This process proceeds to step S380 of connecting the WAN 20 to transmit the network packet P1.

The current DPI is to intercept and inspect the packet in the middle when a router is forwarding the network packet P1. However, in the current architecture of the router, a packet in the LAN 10 is transmitted on a data link layer (that is, a media access control (MAC) layer). The packet does not pass through a checkpoint in the network for DPI, and therefore does not effectively protect the LAN 10. Through the network device 200 and the network control method provided in the disclosure, the destination address of the packet of the LAN 10 is translated into a WAN address, so that the packet is forwarded from the LAN 10 to the WAN 20 for content inspection, and then the packet is forwarded from the WAN 20 back to the LAN 10 through the communication port forwarding mechanism. In this way, DPI is performed on the packet to perform further network security protection.

The foregoing descriptions are merely preferred embodiments of the disclosure, and do not impose any limitation on the disclosure. Any form of change such as an equivalent replacement or modification made by any person skilled in the art to technical means and technical content disclosed in the disclosure without departing from scope of the technical means of the disclosure is content that does not deviate from the technical means of the disclosure, and still falls within protection scope of the disclosure.

What is claimed is:

1. A network device, adapted to connect to a local area network (LAN) and a wide area network (WAN) to receive a network packet, and having a forward chain, wherein the forward chain is adapted to perform content inspection on the network packet before transmitting the network packet to the WAN, and the network device comprising:
a LAN port, adapted to be electrically coupled to the LAN;
a WAN port, adapted to be electrically coupled to the WAN;
a network packet determination unit, electrically coupled to the LAN port and adapted to determine whether a destination address of the network packet is a LAN address; and
a network address translation (NAT) unit, electrically coupled to the network packet determination unit and adapted to perform address translation on the destination address, wherein
when the destination address is the LAN address, the NAT unit translates the destination address into a WAN address, and sends the network packet to the forward chain for content inspection.

2. The network device according to claim 1, further comprising a network packet forwarding unit, wherein the network packet forwarding unit is electrically coupled to the NAT unit, and is adapted to forward the inspected network packet from the WAN address to the LAN address.

3. The network device according to claim 1, wherein the forward chain is adapted to perform deep packet inspection (DPI) on the network packet.

4. The network device according to claim 1, wherein the network device is a router, a switch, or a gateway.

5. The network device according to claim 1, wherein the network packet forwarding unit is adapted to forward the network packet from the WAN address back to destination address through a communication port forwarding mechanism.

6. A network control method, applicable to a network device, wherein the network device is connected to a LAN and a WAN to receive a network packet, and has a forward chain, the forward chain is adapted to perform content inspection on the network packet before transmitting the network packet to the WAN, and the network control method comprising:
determining whether a destination address of the network packet is a LAN address; and
translating the destination address into a WAN address when the destination address is the LAN address, and sending the network packet to the forward chain for content inspection.

7. The network control method according to claim 6, wherein the forward chain is adapted to perform DPI on the network packet.

8. The network control method according to claim 6, wherein the network device is a router, a switch, or a gateway.

9. The network control method according to claim 6, further comprising:
forwarding, from the WAN address to the destination address, the network packet determined to be harmless.

10. The network control method according to claim 9, wherein the step of forwarding, from the WAN address to the destination address is to forward the network packet from the WAN address to destination address through a communication port forwarding mechanism.
